(19) United States
(12) Patent Application Publication
(10) Pub. No.: US 2016/0248886 A1
(43) Pub. Date: Aug. 25, 2016

(54) SPLIT-CLIENT CONSTRAINED APPLICATION EXECUTION IN AN INDUSTRIAL NETWORK

(71) Applicant: Cisco Technology, Inc., San Jose, CA (US)

(72) Inventors: PASCAL THUBERT, La Colle Sur Loup (FR); PATRICK WETTERWALD, Mouans Sartoux (FR)

(21) Appl. No.: 14/629,884

(22) Filed: Feb. 24, 2015

(51) Int. Cl. H04L 29/06; H04L 12/24

(52) U.S. Cl. CPC H04L 67/40; H04L 41/50; H04L 63/062

(57) ABSTRACT

In one embodiment, a method comprises establishing, by a requesting network device, a relationship with a destination device configured for executing one or more device operations in response to receiving a server result; and sending, by the requesting network device, a constrained request to a stateless server device, the constrained request specifying a command for the stateless server device to generate and send the server result to the destination device, the constrained request causing the stateless server device to generate and output the server result to the destination device and not to the requesting network device.

### TECHNICAL FIELD

The present disclosure generally relates to constrained network devices operating as split client devices for communication with a server device according to a constrained application protocol, for example sensor and actuator devices communicating with a programmable logic controller (PLC) in an industrial network.

### BACKGROUND

This section describes approaches that could be employed, but are not necessarily approaches that have been previously conceived or employed. Hence, unless explicitly specified otherwise, any approaches described in this section are not prior art to the claims in this application, and any approaches described in this section are not admitted to be prior art by inclusion in this section.

Industrial networks have utilized programmable logic controllers (PLCs) to provide logical control of industrial devices such as sensor devices or actuator devices using open-loop control or closed-loop (e.g., feedback) control. The Internet Engineering Task Force (IETF) is attempting to propose standards that can be applied to the stringent requirements of industrial networks. For example, Low power and Lossy Networks (LLNs) allow a large number (e.g., tens of thousands) of resource-constrained devices to be interconnected to form a wireless mesh network. The IETF has proposed a routing protocol (“6TiSCH”) that provides IPv6 routing using time slotted channel hopping (TSCH) based on IEEE 802.15.4e, enabling LLN devices to use low-power operation and channel hopping for higher reliability. Constrained Application Protocol (CoAP) is a web transfer protocol proposed for resource constrained devices, where a client device can send a request, and a server device can send a response, via a datagram-oriented transport such as User Datagram Protocol (UDP).

### BRIEF DESCRIPTION OF THE DRAWINGS

Reference is made to the attached drawings, wherein elements having the same reference numeral designations represent like elements throughout and wherein:

FIG. 1 is a diagram illustrating an example system having a stateless server device for sending server results to a destination device and not to a requesting network device having sent a constrained request for the server results, according to an example embodiment.

FIG. 2 is a diagram illustrating an example implementation of any one of the requesting network device, the stateless server device, or the destination device of FIG. 1, according to an example embodiment.

FIGS. 3A and 3B are diagrams summarizing a method by the requesting network device, the stateless server device, and/or the destination device of FIG. 1 of executing split-client constrained application operations, according to an example embodiment.

### DESCRIPTION OF EXAMPLE EMBODIMENTS

### Overview

In one embodiment, a method comprises establishing, by a requesting network device, a relationship with a destination device configured for executing one or more device operations in response to receiving a server result; and sending, by the requesting network device, a constrained request to a stateless server device, the constrained request specifying a command for the stateless server device to generate and send the server result to the destination device, the constrained request causing the stateless server device to generate and output the server result to the destination device and not to the requesting network device.

In another embodiment, an apparatus comprises a processor circuit and a device interface circuit. The processor circuit is configured for establishing a relationship with a destination device configured for executing one or more device operations in response to receiving a server result. The processor circuit further is configured for generating a constrained request for a stateless server device, the constrained request specifying a command for the stateless server device to generate and send the server result to the destination device. The device interface circuit is configured for outputting the constrained request to the stateless server device, the constrained request causing the stateless server device to generate and output the server result to the destination device and not to the requesting network device.

In another embodiment, logic is encoded in one or more non-transitory tangible media for execution by a machine and when executed by the machine operable for: establishing, by a requesting network device, a relationship with a destination device configured for executing one or more device operations in response to receiving a server result; and sending, by the requesting network device, a constrained request to a stateless server device, the constrained request specifying a command for the stateless server device to generate and send the server result to the destination device, the constrained request causing the stateless server device to generate and output the server result to the destination device and not to the requesting network device.

In another embodiment, a method comprises receiving, by a stateless server device from a requesting network device, a constrained request specifying a command for the stateless server device to generate and send a server result to a destination device distinct from the requesting network device; generating, by the stateless server device, the server result according to stateless logic based on the constrained request; and outputting, by the stateless server device, the server result to the destination device and not to the requesting network device.

In another embodiment, an apparatus comprises a device interface circuit and a processor circuit. The device interface circuit is configured for receiving, from a requesting network device, a constrained request specifying a command for the apparatus to generate and send a server result to a destination device distinct from the requesting network device. The processor circuit is configured for generating the server result according to stateless logic based on the constrained request. The device interface circuit further is configured for outputting the server result to the destination device and not to the requesting network device.

In another embodiment, logic is encoded in one or more non-transitory tangible media for execution by a machine and when executed by the machine operable for: receiving, by a stateless server device from a requesting network device, a constrained request specifying a command for the stateless server device to generate and send a server result to a destination device distinct from the requesting network device; generating, by the stateless server device, the server result according to stateless logic based on the constrained request; and outputting, by the stateless server device, the server result to the destination device and not to the requesting network device.

### DETAILED DESCRIPTION

Particular embodiments enable a constrained application protocol to be deployed in an industrial control loop based on splitting client operations in a client-server model. The client operations in the client-server model are split into a requesting client device (also referred to as “requesting network device” or “source network device”) and a destination client device (also referred to as “destination device”) that is distinct from the requesting client device. The requesting client device is configured for sending a constrained request to a stateless server device. The stateless server device is configured for generating a response to the constrained request based on stateless logic (e.g., a Representational State Transfer (REST) architecture), and the stateless server device is further configured for sending the response to the destination device instead of the requesting client device.

Hence, example embodiments enable a constrained application protocol (e.g., CoAP) to be implemented in an industrial network requiring three-tiered data flows between a source network device (e.g., a sensor device), a stateless server device (e.g., a PLC), and a destination device (e.g., an actuator). Hence, a source network device can arbitrarily select any available server device for lightweight RESTful operations, with minimal messaging between the source network device, the server device, and the destination device.

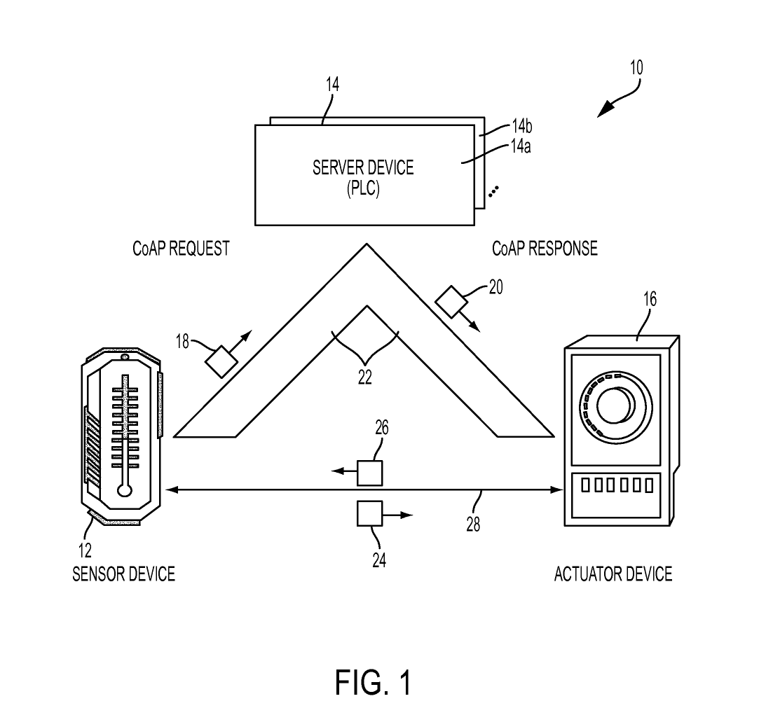

FIG. 1 is a diagram illustrating an example system 10 having a requesting network device 12, a stateless server device 14, and a destination device 16, according to an example embodiment. The requesting network device 12 can be a constrained network device (e.g., an Internet of Things (IoT) enabled sensor device or “mote”) that is configured for sending a constrained request 18 to the stateless server device 14. The stateless server device 14 can be a constrained server or network-based network controller (e.g., an IoT-enabled device controller). The destination device 16 can be a constrained network device (e.g., an IoT enabled actuator or industrial machine controller) configured for responding to commands received from the stateless server device 14. Hence, the requesting network device 12, the stateless server device 14, and the destination device 16 can form an IoT control loop that can communicate one or more constrained request messages 18 from the requesting network device 12 to the stateless server device 14, and one or more server response messages 20 from the stateless server device 14 to the destination device 16, via a deterministic network path 22. The requesting network device 12 and the destination device 16 also can establish a relationship (e.g., a sensor-to-actuator relationship) based on exchanging status messages 24, 26 via a non-deterministic network path 28. The status messages 24, 26 also can be used to maintain the relationship, for example in the form of a persistent “maintenance” session.

As illustrated in FIG. 1, the system 10 illustrates an IoT control loop having a caret-shaped control loop topology along the deterministic network path 22 from the requesting network device 12 to the destination device 16 via the stateless server device 14 in a “caret” shape (“̂”) illustrated in FIG. 1, also referred to as a circumflex accent or diacritic. The optional non-deterministic network path 28 used by the requesting network device 12 and the destination device 16 to maintain a maintenance session (to maintain the relationship between the requesting network device 12 and the destination device 16) enables the IoT control loop topology to form a triangular shape as a subset of the caret-shaped control loop topology.

The requesting network device 12, implemented for example as an IoT sensor device, can output a constrained request 18 for execution by the stateless server device 14. The constrained request 18, implemented for example as a CoAP request according to the Internet Engineering Task Force (IETF) Request for Comments (RFC) 7252, can specify a stateless (e.g., RESTful) server operation to be performed by the server device 14. As described in further detail below, the constrained request 18 can explicitly address the stateless server device 14 within a unicast data packet, or the constrained request 18 can specify a multicast address allocated for any one of a plurality of available server devices 14. The constrained request 18 also can specify parameters associated with the stateless server operation to be performed, for example sensor parameters generated by the requesting network device 12 (e.g., temperature data, humidity data, etc.).

Since the requesting network device 12 and the destination device 16 are distinct network devices, the constrained request 18 generated and output by the requesting network device 12 can include information that enables the stateless server device 14 to determine that the destination device 16 (and not the requesting network device 12) is to receive the response to the request: example information can include destination information for reaching the destination device 16 (e.g., IP address, UDP port number, etc.); other example information can include one or more security credentials or keys (e.g., secure tokens) claimed by the requesting network device 12 and/or the destination device 16, enabling the stateless server device 14 to determine that the requesting network device 12 and the destination device 16 have a security relationship that grants authority to the destination device 16 to receive the server response message 20 requested by the requesting network device 12; other example information can include a transmission schedule, for example a time slotted channel hopping (TSCH) schedule in a wireless deterministic network employing IPv6 over the TSCH mode of IEEE 802.15.4e (6TiSCH). The destination information, security credentials and/or the transmission schedule can be implemented as new option fields within a CoAP request.

Hence, the stateless server device 14, in response to receiving the constrained request 18 from the requesting network device 12 via the deterministic network path 22, can generate the server response message 20 according to stateless logic based on parameters specified in the constrained request 18, and output the server response message 20 to the destination device 16 via the deterministic network path 22 based on the transmission schedule specified in the constrained request 18. As apparent from the foregoing, the constrained request 18 output by the requesting network device 12 can specify all parameters necessary for the stateless server device 14 to generate and output the server response message 20 to the destination device 16 (as opposed to the requesting network device 12); hence, any available stateless server device 14 can be used to execute the operations associated with maintaining the control loop 10. Hence, the requesting network device 12 can arbitrarily send the constrained request 18 to any available stateless server device 14 for generation of the server response message 20 for the destination device 16, for example according to a round-robin selection scheme for load balancing purposes, or selection of an alternate stateless server device 14 (e.g., 14b) in response to the destination device 16 sending a destination device status message 26 specifying a determined absence of any server response message 20 (i.e., that no server response message 20 has been received for at least a prescribed interval), for example in the case that the destination device 16 was sending constrained requests to a stateless server device 14a that is no longer available.

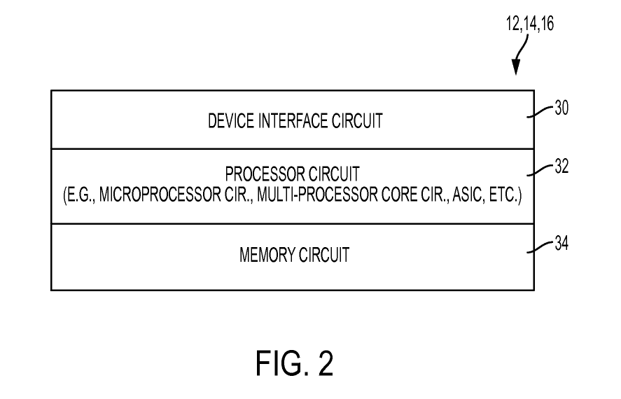

FIG. 2 illustrates an example implementation of any one of the devices 12, 14, and/or 16 of FIG. 1, according to an example embodiment. Each apparatus 12, 14, and/or 16 is a physical machine (i.e., a hardware device) configured for implementing network communications with the other physical machines via the deterministic network path 22 and/or the non-deterministic network path 28 as described herein. The term “configured for” or “configured to” as used herein with respect to a specified operation refers to a device and/or machine that is physically constructed and arranged to perform the specified operation.

Each apparatus 12, 14, and/or 16 can include a device interface circuit 30, a processor circuit 32, and a memory circuit 34. Although not illustrated in FIG. 2, the requesting network device 12 also can include input devices, input sensors, etc., for detection and/or collection of data to be used to generate a server response message 20 for the destination device 16; the destination device 16 also can include output or control devices responsive to the server response message 20, for example actuator devices (mechanical, electrical, optical, acoustic, etc.) for (automated) control of systems in an industrial environment or the like.

The device interface circuit 30 can include one or more distinct physical layer transceivers for communication with any one of the other devices 12, 14, and/or 16; the device interface circuit 30 also can include an IEEE based wired Ethernet transceiver, a wireless IEEE 802.15.4e transceiver, and/or an optical transceiver, etc., for communications with the devices of FIG. 1 via any of the paths 22 or 28 as described herein via wired or wireless links (e.g., a wired or wireless link, an optical link, etc.). The processor circuit 32 can be configured for executing any of the operations described herein, and the memory circuit 34 can be configured for storing any data or data packets as described herein.

Any of the disclosed circuits of the devices 12, 14, and/or 16 (including the device interface circuit 30, the processor circuit 32, the memory circuit 34, and their associated components) can be implemented in multiple forms. Although the example embodiments illustrate formation of a closed-loop control path for constrained devices 12, 14, and 16 using deterministic network paths 22 to provide time-synchronized delivery of data packets within a bounded time (providing high delivery ratio, faxed latency, and near-zero jitter on the order of microseconds), other implementations can employ the disclosed split-client application execution as well.

Example implementations of the disclosed circuits can include hardware logic that is implemented in a logic array such as a programmable logic array (PLA), a field programmable gate array (FPGA), or by mask programming of integrated circuits such as an application-specific integrated circuit (ASIC). Any of these circuits also can be implemented using a software-based executable resource that is executed by a corresponding internal processor circuit such as a microprocessor circuit (not shown) and implemented using one or more integrated circuits, where execution of executable code stored in an internal memory circuit (e.g., within the memory circuit 34) causes the integrated circuit(s) implementing the processor circuit to store application state variables in processor memory, creating an executable application resource (e.g., an application instance) that performs the operations of the circuit as described herein. Hence, use of the term “circuit” in this specification refers to both a hardware-based circuit implemented using one or more integrated circuits and that includes logic for performing the described operations, or a software-based circuit that includes a processor circuit (implemented using one or more integrated circuits), the processor circuit including a reserved portion of processor memory for storage of application state data and application variables that are modified by execution of the executable code by a processor circuit. The memory circuit 34 can be implemented, for example, using a non-volatile memory such as a programmable read only memory (PROM) or an EPROM, and/or a volatile memory such as a DRAM, etc.

Further, any reference to “outputting a message” or “outputting a packet” (or the like) can be implemented based on creating the message/packet in the form of a data structure and storing that data structure in a non-transitory tangible memory medium in the disclosed apparatus (e.g., in a transmit buffer). Any reference to “outputting a message” or “outputting a packet” (or the like) also can include electrically transmitting (e.g., via wired electric current or wireless electric field, as appropriate) the message/packet stored in the non-transitory tangible memory medium to another network node via a communications medium (e.g., a wired or wireless link, as appropriate) (optical transmission also can be used, as appropriate). Similarly, any reference to “receiving a message” or “receiving a packet” (or the like) can be implemented based on the disclosed apparatus detecting the electrical (or optical) transmission of the message/packet on the communications medium, and storing the detected transmission as a data structure in a non-transitory tangible memory medium in the disclosed apparatus (e.g., in a receive buffer). Also note that the memory circuit 34 can be implemented dynamically by the processor circuit 32, for example based on memory address assignment and partitioning executed by the processor circuit 32.

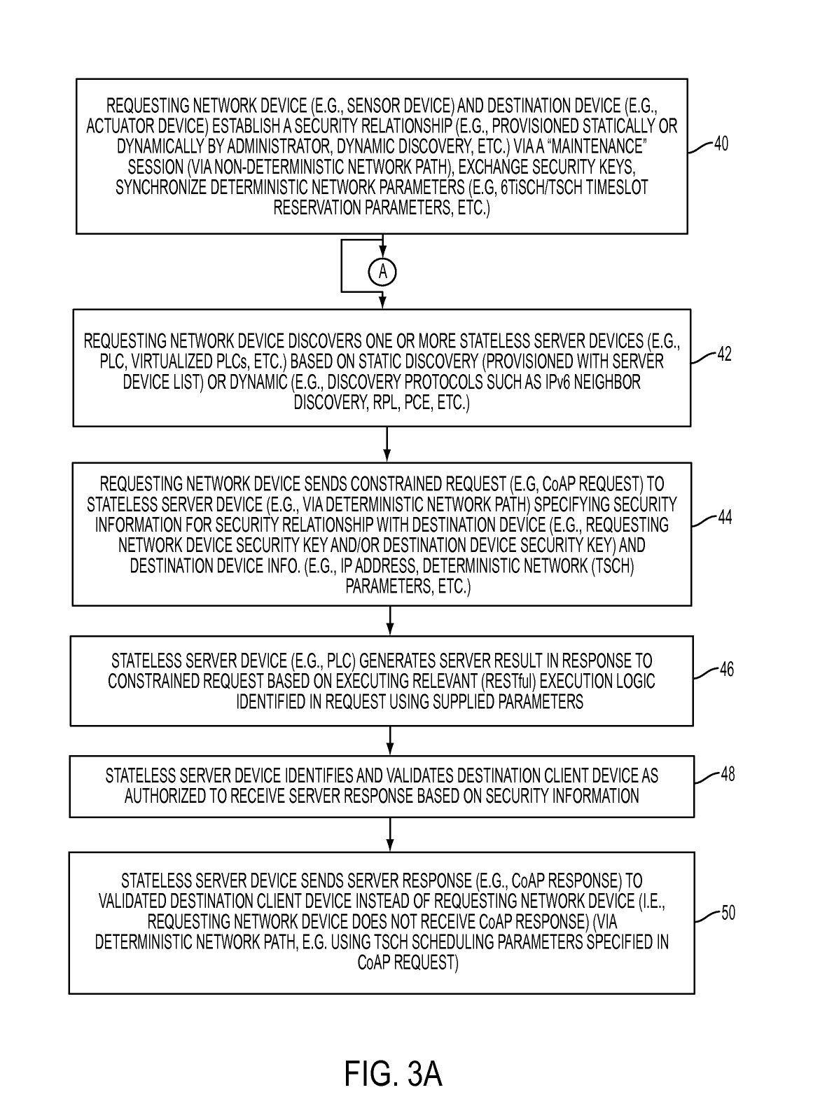

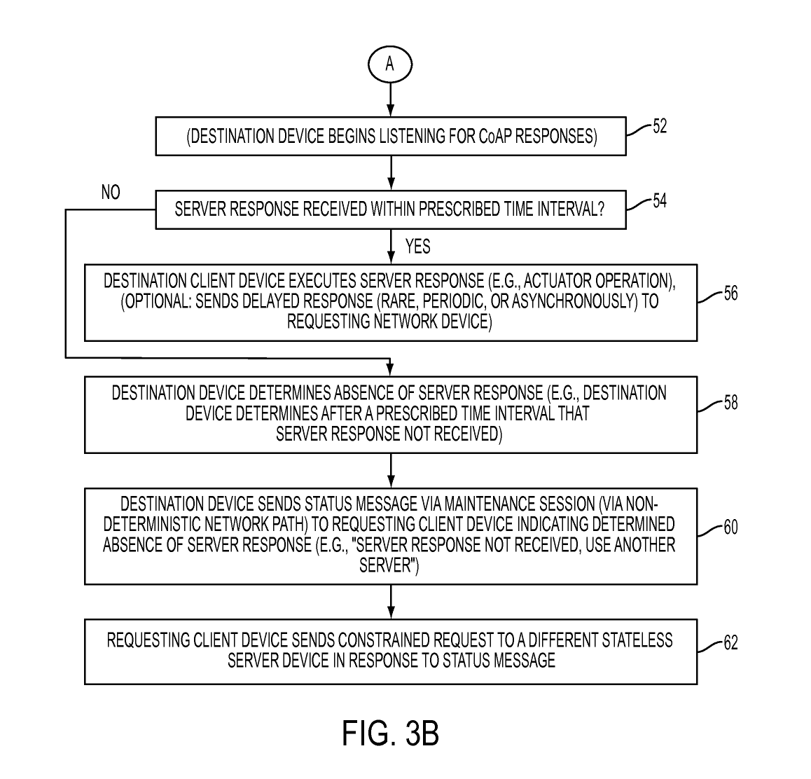

FIGS. 3A and 3B are diagrams summarizing a method by the requesting network device, the stateless server device, and/or the destination device of FIG. 1 of executing split-client constrained application operations, according to an example embodiment. The operations described in any of the Figures can be implemented as executable code stored on a computer or machine readable non-transitory tangible storage medium (e.g., floppy disk, hard disk, ROM, EEPROM, nonvolatile RAM, CD-ROM, etc.) that are completed based on execution of the code by a processor circuit implemented using one or more integrated circuits; the operations described herein also can be implemented as executable logic that is encoded in one or more non-transitory tangible media for execution (e.g., programmable logic arrays or devices, field programmable gate arrays, programmable array logic, application specific integrated circuits, etc.).

In addition, the operations described with respect to any of the Figures can be performed in any suitable order, or at least some of the operations in parallel. Execution of the operations as described herein is by way of illustration only; as such, the operations do not necessarily need to be executed by the machine-based hardware components as described herein; to the contrary, other machine-based hardware components can be used to execute the disclosed operations in any appropriate order, or at least some of the operations in parallel.

Referring to FIG. 3A, the device interface circuit 30 of the requesting network device 12 and the destination device 16 are configured for establishing a security relationship via the non-deterministic network path 28, based on exchanging status messages 24 and 26 generated by the respective processor circuits 32. The non-deterministic network path 28 can be established between the requesting network device 12 and the destination device 16 according to different routing protocols, for example IPv6 Routing Protocol for Low-Power and Lossy Networks (RPL) as specified in RFC 6550. The security relationship also can be provisioned statically by a network administrator, an industrial network administrator, etc.; the security relationship also can be provisioned dynamically based on IP based discovery (e.g., neighbor discovery, RPL, internal DNS query and resolutions, etc.). The security relationship can be established as part of a “maintenance” session established between the requesting network device 12 and the destination device 16, where the requesting network device 12 and the destination device 16 can exchange security keys (e.g., secure tokens), and negotiate deterministic network parameters (e.g., timeslot reservation in 6TiSCH) for establishment of the deterministic network path 22 from the requesting network device 12 to the destination device 16. The requesting network device 12 and the destination device 16 also can establish the deterministic network path 22 based on deterministic network parameters received from a prescribed entity, such as a Path Computation Entity (PCE) or an “Orchestrator” (not shown).

Following establishment of the security relationship in operation 40 including establishment of the deterministic network path 22, the destination device 16 can begin “listening” (operation 52 of FIG. 3B) on an identifiable IP address (and UDP port) for commands specified in a server response message 20 generated by a stateless server device 14 (described below with respect to FIG. 3B). The requesting network device 12 in operation 42 of FIG. 3A can discover one or more stateless server devices 14, for example based on static discovery (e.g., having been provisioned with a server device list stored in the memory circuit 34), or dynamic discovery from a network administrator (e.g., a PCE, an Orchestrator, etc.), or a discovery protocol (e.g., IPv6 Neighbor Discovery, RPL), etc.

In response to detecting one or more stateless server devices 14, the processor circuit 32 of the requesting network device 12 in operation 44 can generate a constrained request 18 in response to a prescribed condition, for example in response to one or more physical sensors reaching an identifiable threshold in an industrial environment (e.g., temperature, humidity, voltage, distance, speed, acceleration, radiation level, etc.). The constrained request 18 can be implemented as a CoAP request specifying reachability information for reaching the destination device 16 (e.g., IP address, UDP port number used by the destination device 16 to listen for the server response message 20 in operation 52), sensor information that triggered sending the destination device 16, a reference (e.g., a Uniform Resource Identifier (URI)) that identifies the stateless operation to be performed; the constrained request 18 also can specify security information (e.g., security keys for the requesting network device 12 and/or the destination device 16) that authenticates the security relationship between the requesting network device 12 and the destination device 16 and enables the processor circuit 32 of the stateless server device 14 to verify that the server response message 20 is destined for the destination device 16. The constrained request 18 also can specify a message identifier for use by the destination device 16 in tracking and maintaining the persistent session between the requesting network device 12 and the destination device 16 via the non-deterministic network path 28 (e.g., in case the requesting network device 12 requires an acknowledgement from the destination device 16). The device interface circuit 30 of the requesting network device 12 in operation 44 can output the constrained request 18 to the stateless server device 14 (e.g., 14a) via the deterministic network path 22. Depending on implementation, the constrained request 18 can be unicast by the device interface circuit 30 to a specific stateless server device 14, unicast to a front-end scheduler (e.g., a load-balancer or a hypervisor managing execution of multiple virtualized stateless server devices 14 within respective virtual machines), or multicast to multiple stateless server devices 14.

In response to the device interface circuit 30 of the stateless server device 14 receiving in operation 46 the constrained request 18 from the requesting network device 12 via the deterministic network path 22, the processor circuit 32 of the stateless server device 14 can parse the execution parameters supplied in the constrained request 18, and in response execute relevant RESTful execution logic to generate the server response message 20 in operation 46. In particular, the constrained request 18 can specify a URI identifying the stateless logic operations (“method”) to be performed (e.g., enabling retrieval of executable code associated with the URI from the memory circuit 34 of the stateless server device 14 or another “back-end” server device) on the supplied operational parameters (e.g., sensor information). The processor circuit 32 of the stateless server device 14 also can identify and validate in operation 48 the destination device 16 as the destination client device that is authorized to receive the server response message 20 instead of the requesting network device 12, based on the processor circuit 32 determining that the destination device 16 has a security relationship with the requesting network device 12. The processor circuit 32 of the stateless server device 14 can cause the device interface circuit 30 to output in operation 50 the server response message 20 to the destination device 16 via the deterministic network path 22 based on the scheduling parameters specified in the constrained request 18. Hence, the stateless server device 14 can process a constrained request 18 (implemented as a modified confirmable CoAP request) based on sending the “acknowledgement” associated with the “confirmable CoAP request) to the destination device 16.

Referring to FIG. 3B, the device interface circuit 30 of the destination device 16 in operation 52 can listen for the server response message 20 (e.g., CoAP responses) at the destination (IP address, UDP port) negotiated with the requesting network device 12 in operation 40. In response to the device interface circuit 30 receiving the server response message 20 in operation 54, the processor circuit 32 of the destination device 16 can execute the server response, for example implementing an actuator control. If desired, the processor circuit 32 of the destination device 16 can output in operation 56 a destination device status message 26 (specifying the message identifier) via the non-deterministic network path 28, enabling the requesting network device 12 to confirm the constrained request 18 has been successfully executed by the stateless server device 14 and the destination device 16. Depending on implementation, the destination device status message 26 can be output on a rare basis (e.g., responsive only to high-priority data such as alarm data), a periodic basis, or asynchronously depending on session state between the two devices 12 and 16.

As described previously, the persistent state maintained by the exchange of status messages 24 and 26 via the non-deterministic network path 28 enables the requesting network device 12 to select an alternative stateless server device 14 in the event that a given stateless server device 14 (e.g., 14a) is not responding to the constrained request 18 (e.g., due to a failure in the stateless server device 14 or a failure in a link between the requesting network device 12 and the stateless server device 14). Referring to operation 54, if the processor circuit 32 of the destination device 16 determines that a server response message 20 has not been received for a prescribed interval, the processor circuit 32 in operation 58 can determine an absence of a required server response message 20, and in response send in operation 60 a destination device status message 26 via the non-deterministic network path 28 and specifying that the required server response message 20 has not been received by the destination device 16. The processor circuit 32 of the requesting network device 12 can respond in operation 62 to the received destination device status message 26 by selecting another stateless server device 14 for subsequent 18, and optionally sending a notification message to a network management entity (e.g., a PCE, an administrator, etc.).

According to example embodiments, a constrained application protocol can be deployed in an industrial control loop based on splitting client operations in a client-server model. A stateless server device can generate a response to the constrained request based on stateless logic, and send the response to the destination device instead of the requesting client device, enabling arbitrary selection of a server device for lightweight RESTful operations, with minimal messaging between the source network device, the server device, and the destination device. The split-client operations eliminate the necessity of repeated acknowledgements between the server device and the requesting client device via valuable (i.e., high-priority) deterministic network paths, as the requesting client device can rely on the destination device to notify the requesting client device via lower-priority non-deterministic paths if responses are not being received. Hence, the example embodiments enable deployment of an IoT control loop in a deterministic network using a RESTful with minimal messaging.

While the example embodiments in the present disclosure have been described in connection with what is presently considered to be the best mode for carrying out the subject matter specified in the appended claims, it is to be understood that the example embodiments are only illustrative, and are not to restrict the subject matter specified in the appended claims.

What is claimed is:

1. A method comprising:
establishing, by a requesting network device, a relationship with a destination device configured for executing one or more device operations in response to receiving a server result; and
sending, by the requesting network device, a constrained request to a stateless server device, the constrained request specifying a command for the stateless server device to generate and send the server result to the destination device, the constrained request causing the stateless server device to generate and output the server result to the destination device and not to the requesting network device.

2. The method of claim 1, wherein the establishing includes establishing a security relationship with the destination device, the sending including sending within the constrained request a security key identifying the security relationship.

3. The method of claim 1, wherein the establishing includes establishing a transmission schedule for transmission of the constrained request to the stateless server device, and for reception of the corresponding server result by the destination device.

4. The method of claim 3, wherein the sending includes specifying the transmission schedule in the constrained request, enabling the stateless server device to output the server result to the destination device according to the transmission schedule.

5. The method of claim 1, further comprising:
receiving, by the requesting network device, a status message from the destination device indicating a determined absence by the destination device of the server result; and
sending, by the requesting network device, the constrained request to a second stateless server device in response to the status message.

6. The method of claim 5, further comprising:
receiving a message from a Path Computation Element device identifying the stateless server device and the second stateless server device;
the sending includes sending the constrained request via a deterministic network path;
the receiving of the status message is via a non-deterministic network path.

7. An apparatus comprising:
a processor circuit configured for establishing a relationship with a destination device configured for executing one or more device operations in response to receiving a server result, the processor circuit further configured for generating a constrained request for a stateless server device, the constrained request specifying a command for the stateless server device to generate and send the server result to the destination device; and
a device interface circuit configured for outputting the constrained request to the stateless server device, the constrained request causing the stateless server device to generate and output the server result to the destination device and not to the requesting network device.

8. The apparatus of claim 7, wherein the processor circuit is configured for establishing a security relationship with the destination device, the constrained request generated by the processor circuit further specifying a security key identifying the security relationship.

9. The apparatus of claim 7, wherein the processor circuit is configured for establishing a transmission schedule for transmission of the constrained request to the stateless server device, and for reception of the corresponding server result by the destination device.

10. The apparatus of claim 9, wherein the processor circuit is configured for specifying the transmission schedule in the constrained request, enabling the stateless server device to output the server result to the destination device according to the transmission schedule.

11. The apparatus of claim 7, wherein:
the device interface circuit is configured for receiving, from the destination device, a status message indicating a determined absence by the destination device of the server result;
the processor circuit configured for causing the device interface circuit to send the constrained request to a second stateless server device in response to the status message.

12. The apparatus of claim 11, wherein:
the device interface circuit is configured for receiving a message from a Path Computation Element device identifying the stateless server device and the second stateless server device;
the processor circuit configured for generating the constrained request, for transmission by the device interface via a deterministic network path, based on the message from the Path Computation Element device;
the device interface circuit is configured for receiving the status message via a non-deterministic network path.

13. Logic encoded in one or more non-transitory tangible media for execution by a machine and when executed by the machine operable for:
establishing, by a requesting network device, a relationship with a destination device configured for executing one or more device operations in response to receiving a server result; and
sending, by the requesting network device, a constrained request to a stateless server device, the constrained request specifying a command for the stateless server device to generate and send the server result to the destination device, the constrained request causing the stateless server device to generate and output the server result to the destination device and not to the requesting network device.

14. A method comprising:
receiving, by a stateless server device from a requesting network device, a constrained request specifying a command for the stateless server device to generate and send a server result to a destination device distinct from the requesting network device;
generating, by the stateless server device, the server result according to stateless logic based on the constrained request; and
outputting, by the stateless server device, the server result to the destination device and not to the requesting network device.

15. The method of claim 14, wherein the constrained request includes a security key identifying a security relationship between the requesting network device and the destination device, the stateless server device outputting the server result to the destination device based on the security relationship.

16. The method of claim 14, wherein:
the constrained request specifies a transmission schedule of the destination device relative to the requesting network device;
the outputting includes outputting the server result to the destination device based on the transmission schedule.

17. An apparatus comprising:
a device interface circuit configured for receiving, from a requesting network device, a constrained request specifying a command for the apparatus to generate and send a server result to a destination device distinct from the requesting network device; and
a processor circuit configured for generating the server result according to stateless logic based on the constrained request;
the device interface circuit further configured for outputting the server result to the destination device and not to the requesting network device.

18. The apparatus of claim 17, wherein the constrained request includes a security key identifying a security relationship between the requesting network device and the destination device, the processor circuit generating the server result for output to the destination device based on the security relationship.

19. The apparatus of claim 17, wherein:
the constrained request specifies a transmission schedule of the destination device relative to the requesting network device;
the device interface circuit configured for outputting the server result to the destination device based on the transmission schedule.

20. Logic encoded in one or more non-transitory tangible media for execution by a machine and when executed by the machine operable for:
receiving, by a stateless server device from a requesting network device, a constrained request specifying a command for the stateless server device to generate and send a server result to a destination device distinct from the requesting network device;
generating, by the stateless server device, the server result based on the constrained request; and
outputting, by the stateless server device, the server result to the destination device and not to the requesting network device.
